(19) United States
(12) Patent Application Publication
(10) Pub. No.: US 2026/0045238 A1
(43) Pub. Date: Feb. 12, 2026

(54) IMPROVED KEY WEIGHTS FOR PIANO

(71) Applicant: Jacob RICHTER, Tel Aviv (IL)

(72) Inventor: Jacob RICHTER, Tel Aviv (IL)

(21) Appl. No.: 18/998,571

(22) PCT Filed: Jul. 26, 2022
(86) PCT No.: PCT/IB2022/056887

§ 371 Date: Jan. 27, 2025

(51) Int. Cl. G10C 3/12; G10C 9/00

(52) U.S. Cl. CPC G10C 3/125; G10C 9/00

(57) ABSTRACT

A weight and method for installing the same in a piano key or damper, the method including: providing a weight formed from material including a metal having a density greater than 12 grams per cubic centimeter; inserting the weight into the piano key or damper. The material including at least a metal sufficiently strong to form a thread on a surface thereof; and wherein the weight has a thread formed on the surface. The material is resistant to corrosion at least at ambient temperatures The weight being a cylindrical member made of lead; and at least one outer layer of an inert metal material or a corrosion-resistant metal material covering the cylindrical member.

### FIELD OF THE INVENTION

The present invention relates to pianos and, more particularly, to weights embedded in the piano keys.

### BACKGROUND OF THE INVENTION

Lead weights have been used in piano keys (see for example FIG. 1) since the first pianos. The balancing of the resistance of keys in a piano keyboard, so that it will be equal or set at a known gradient of resistance along the keyboard from the bass keys to the treble keys has been a basic technique in piano design and construction.

The traditional key-weights are made as cylinders of lead having diameters of typically 13 mm or 10 mm. The cylinders are inserted into holes drilled in the wooden part of the key and then swaged to anchor them in the hole by slightly increasing their diameter by hammering or using a press. FIG. 2 shows a prior art method of swaging a lead weight by hammering a steel rod 30 into the weight. Swaging is enabled by the softness of the metal. FIG. 3 depicts a prior art lead weight 20 that has oxidized 22. Swaging marks 24 are evident on the head or top of the lead weight 20. The resulting keyboard will then have balanced keys with lead weights embedded in them.

Aside from the potential problem of exposing the player to lead, considered today as having toxic properties, there are at least two more major disadvantages to using lead as the material for key weights:
A. The anchoring of the lead weight by swaging may create permanent radial pressure that will eventually cause the wooden key to split. FIG. 4 depicts a piano key 10 that was split by a prior art lead weight 20 that expanded in diameter due to oxidation.
B. Lead tends to oxidize, whether in response to humidity in the atmosphere the piano is located in, or in response to the close interaction with sap residue in the wood it is swaged into.

Oxidation causes the lead weight to expand, either in the diametric dimension, causing more pressure to split the wooden key, or in the longitudinal dimension, extending towards the neighboring key and creating friction between neighboring keys. FIG. 5 depicts a piano key 10 with a prior art lead weight 20 that has expanded longitudinally, causing friction with a neighboring key.

### SUMMARY OF THE INVENTION

According to the present invention there is disclosed a method and an apparatus to be used in order to overcome the major disadvantages of using lead as the material for key weights in pianos as well as providing an improved technique for anchoring the weights in the keys. Disclosed herein are at three types of improvements to existing key weights. The first solution is to provide a key weight of a metal that is sufficiently hard so as to be able to form threads on the surface of the weight, so that it can be screwed into the piano key. A second improvement is to provide a metal that has a higher specific weight / gravity, so that the weight can be smaller. A third improvement is to provide a material that is resistant to oxidation.

One example of a material that fulfils all three improved features is Tungsten.

According to the present invention, three major advantages are achieved:
A. Tungsten (or similar metal) has a considerably lower tendency than lead to oxidize at room temperatures; accordingly, the phenomenon of the key weights swelling due to oxidation will be largely reduced or prevented.
B. The density (specific gravity) of Tungsten (19.25 gr./cm³) is considerably larger than that of lead (11.34 gr./cm³) and therefore the diameter of the drilled hole in the wooden key for weights of similar length will be smaller, reducing the risk of splitting the key.
C. This advantage will be further enhanced by replacing the technique of anchoring the weight by swaging, with the technique of screwing the weight into place by providing an external thread on the surface of the cylindrical weight. The replacement of swaging by screwing is dependent on the replacement of a soft metal such as lead by a much harder one such as Tungsten.

Another method for preventing damage to the wood due to oxidation of the key weights is to coat the lead key weights with one or more layers of an inert metal such as Gold, Silver, etc.

In summary, there is presented is a new weight for piano keys that has a lesser tendency to damage the keys and cause their replacement. By making the weight from a material of higher specific gravity, the size of the weight can be smaller than a legacy lead weight. Making the weight from a hard metal with an outside thread that will allow the weight to be inserted into the wooden key without the outside pressure of swaging that tends to split the wood.

According to the present invention there is provided a method for installing a weight in a piano key or damper, the method including: providing a weight formed from material including a metal having a density greater than 12 grams per cubic centimeter; inserting the weight into the piano key or damper.

According to further features in preferred embodiments of the invention described below the method further includes providing an external thread on a curved surface of the weight; and wherein the inserting of the weight includes screwing the cylindrical key weight into a corresponding hole in the piano key or damper.

According to still further features in the described preferred embodiments the corresponding hole has a diameter that is smaller than a diameter of the weight. According to further features the corresponding hole has an internal thread adapted to receive the external thread of the weight.

According to further features the weight is cylindrical. According to further features the metal is tungsten. According to further features the material is an alloy. According to further features the material is tungsten carbide.

According to another embodiment there is provided a method for installing a weight in a piano key or damper, including: providing a weight formed from material including a metal sufficiently strong to form a thread on a surface thereof; forming the thread on the surface; and inserting the weight into the piano key or damper.

According to further features the inserting of the weight includes screwing the weight into a corresponding hole in the piano key or damper. According to further features the corresponding hole is has a diameter that is smaller than a diameter of the weight. According to further features the corresponding hole has an internal thread adapted to receive the external thread of the weight.

According to another embodiment there is provided a weight for a piano key or damper, including: a material including at least a metal having a density greater than 12 grams per cubic centimeter. According to further features the weight has a threaded surface.

According to further features the material has a cylindrical shape. According to further features the metal is tungsten. According to further features the material is a metal alloy. According to further features the metal alloy is tungsten carbide.

According to another embodiment there is provided a weight for a piano key or damper, including: a material including at least a metal sufficiently strong to form a thread on a surface thereof; and wherein the weight has a thread formed on the surface. According to further features the material is resistant to corrosion at least at ambient temperatures.

According to another embodiment there is provided a weight for a piano key or damper, including: a cylindrical member made of lead; and at least one outer layer of an inert metal material or a corrosion-resistant metal material covering the cylindrical member.

According to further features the inert metal is selected from the group including: gold, silver, copper, rhodium, platinum. According to further features the corrosion-resistant metal material is resistant to corrosion at least at ambient temperatures.

### BRIEF DESCRIPTION OF THE DRAWINGS

Various embodiments are herein described, by way of example only, with reference to the accompanying drawings, wherein:

FIG. 1 is a prior art piano key 10 with lead weights 20;

FIG. 2 is a prior art method of swaging a lead weight by hammering a steel rod 30 into the weight;

FIG. 3 is a prior art lead weight 20 that has oxidized 22;

FIG. 4 is a piano key that was split by a prior art lead weight that expanded in diameter due to oxidation;

FIG. 5 is a piano key 10 with a prior art lead weight 20 that has expanded longitudinally, causing friction with a neighboring key;

FIG. 6 is an improved weight 200 according to the instant invention (on the right) next to an oxidized lead weight 20;

FIGS. 7A and 7B are various screw configurations where the thread of the screw is non-contiguous, due to shape or channels formed in the screw.

FIG. 8 is a flow diagram 800 of steps for an improved method of installing the improved weight in a piano key or piano damper.

### DESCRIPTION OF THE PREFERRED EMBODIMENTS

The principles and operation of improved methods and apparatuses for providing key weights in piano keys according to the present invention may be better understood with reference to the drawings and the accompanying description.

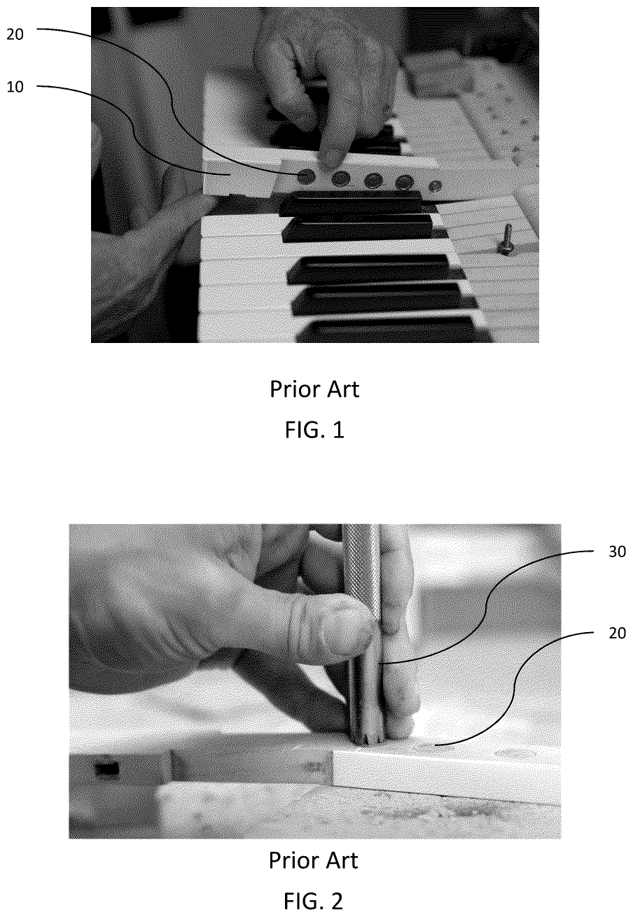

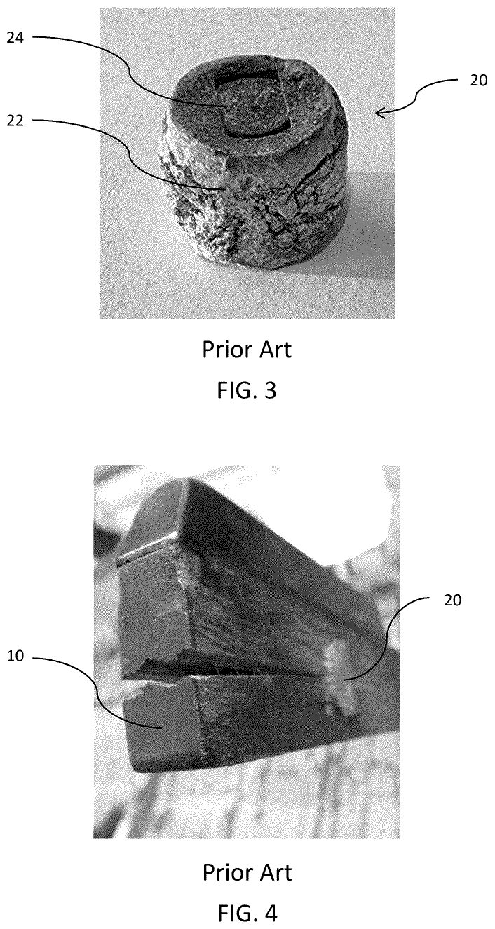

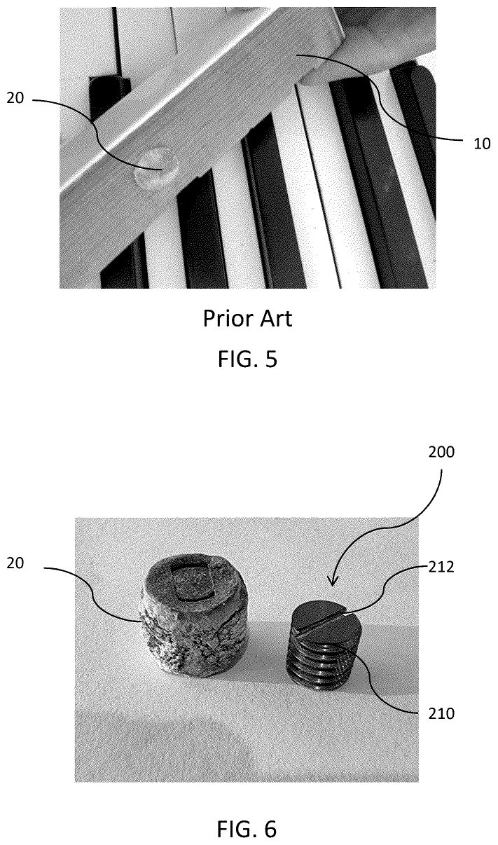

FIG. 1 illustrates a prior art piano key 10 with lead weights 20. The weights were inserted by a process/action called “swaging”. The keys in a piano keyboard are weighted with lead weights. As mentioned above, these weights create an outside pressure that may split the keys due to the swaging and tend to oxidize over time, especially in humid conditions. Piano dampers (not shown) are likewise weighted with lead weights and suffer from the same deficiencies.

The present disclosure provides an alternative weight to be used instead of the prior art lead weight. FIG. 6 illustrates an improved weight 200 according to the instant invention (on the right) next to an oxidized lead weight 20 (on the left). The two metal pieces have approximately the same weight (about 9 grams), yet the Tungsten weight 200 has a smaller diameter and length due to its higher specific gravity.

Traditional, existing weights are usually cylindrical members made of lead which has a density (specific gravity) of 11.34 gr./cm³. Some scientific sources have this number at 11.29 grams per cubic centimeter. According to embodiments, there is provided a weight 200 for a piano key or piano damper formed from a metal that has a density greater than 12 grams per cubic centimeter. The material from which the instant weight is made may be a pure metal answering to the aforementioned definition, or a material that includes at least such a metal. One example of such a metal is tungsten. The example key/damper weight 200 in FIG. 6 is made of tungsten.

In some embodiments, the weight is made of a material that is a metal alloy. One example of such a metal alloy is tungsten carbide.

In embodiments, the weight has a cylindrical shape. In embodiments, the weight has a threaded surface 210. The threaded surface allows the weight to be screwed into a corresponding hole (not shown) in the wooden surface of the piano key or damper, where the hole has a corresponding thread to the thread of the weight. Alternatively, a key may simply have a hole that is somewhat smaller than the outside diameter of the threaded weight. In such a case, the softness of wood relative to the hardness metal will allow for the weight to bite into the wood as it is screwed in, resulting in a very firm and secure bond. This option is known as self-threading (or self-tapping) where the thread cuts into the material when the weight is turned, creating an internal thread that helps pull fastened materials together and prevents pull-out. In preferred embodiments, the weight has a drive to facilitate screwing in the weight with a tool. Example weight 200 has a slotted drive 212.

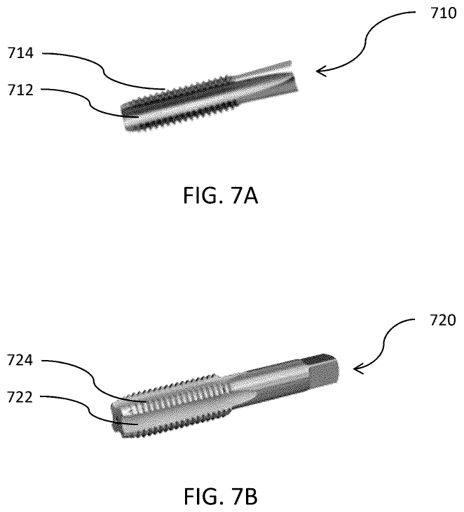

FIGS. 7A and 7B depict various screw configurations where the thread of the screw is non-contiguous, due to shape or channels formed in the screw. These configurations can be adapted for key/damper weights. The screws can be self-threading or adapted for screwing into a hole with a corresponding thread. The voids or channels in the screw design can have many functions, including, for example, providing space for material that is carved out by self-threading screw weights. I.e., a hole is formed in the wooden key with a smaller diameter than the weight; the self-threading weight, when inserted, bites into the wood and shaves off some of that wood; the wood shavings can gather in the ‘channels’ as the weight bores into the wood.

FIG. 7A depicts a screw 710 having a cylindrical design (that can be adapted for a key/damper weight) with a channel 712 formed in through the threads 714. FIG. 7B depicts a square shaped screw 720 (that can be adapted for a key/damper weight) where the ‘corners’ of the screw include threads 724 and the sides or areas between the ‘corners’ form channels 722.

According to embodiments, there is provided a method for installing a weight in a piano key or damper. A weight according to any of the embodiments discussed heretofore is provided. A corresponding hole is provided in the piano key or damper. The weight is inserted into the hole. According to some embodiments, the weight is swaged into the hole. The weight may be swaged with a hammer or press. The smaller diameter and length of the weight according to the embodiments presented above have a smaller impact on the key or damper, and therefore even insertion by swaging, while less preferable, is still an improvement over legacy weights and swaging of those weights. Furthermore, the present weights are formed from a material made of, or at least including, a corrosion-resistant metal.

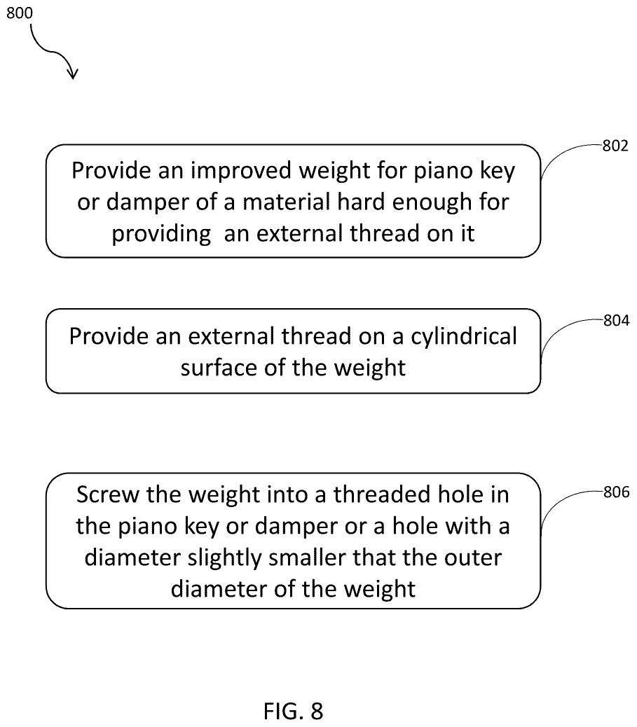

FIG. 8 is a flow diagram 800 of steps for an improved method of installing the improved weight in a piano key or piano damper. The method presented herein only includes the steps that are germane to the invention. It is understood that there may be various steps taken before and/or after the steps described below.

In step 802 a weight formed from material including a metal having a density greater than 12 grams per cubic centimeter is provided. Additionally, or alternatively, there is provided a weight made from a material where the outer surface is hard enough to provide or form a thread thereon. Further additionally, or alternatively, a weight is provided that is made from a metal/material that is highly resistant to oxidation. The weight may only include the material/metal having one or more of the aforementioned properties. Alternatively, the weight may be made of an alloy of a substance/metal having one or more of the aforementioned properties as well as one or more additional substances.

In step 804 an external thread is provided on a curved surface of the weight. In step 806 the weight is screwed into a corresponding hole in a piano key or damper. Screwing (or forcing) the threaded weight into the hole in the key anchors the weight to the key. For example, the key may be provided with a hole with a thread or just with a smooth wall at a diameter smaller than that of the weight.

In some embodiments, the corresponding hole has an internal thread adapted to receive the external thread of the improved weight. In other embodiments, the corresponding hole has a diameter slightly smaller than that of the weight and the process of screwing the weight into the hole creates the thread in the wooden key. In embodiments, the weight is cylindrical. In some cases, the weight may be generally square or rectangular, but with rounded corners.

In embodiments, the metal is tungsten. In embodiments, the material is an alloy, for example, tungsten carbide. The density of tungsten carbide is approximately 14,6 gr/cm³, however, different preparations of the alloy present different densities. In general, the range of densities range between 14,6-15,6 gr/cm³.

Examples of metals with a density (specific gravity) of more than 12 gr/cm³ include, but are not limited to: Mercury (13,570 gr/cm³), Gold (19,320 gr/cm³), Tungsten (19,450 gr/cm³), Platinum (21,425 gr/cm³). Other metals that fit the aforementioned criteria exist. Not all metals (including those mentioned as well as those not listed) are practical for a variety of reasons including, but not limited to, high price, excessive malleability, radiation, etc.

Another possible configuration of an improved weight for a piano key or damper, includes a cylindrical member made of lead (i.e., similar to a legacy lead weight), where the cylinder is augmented with at least one outer layer of an inert metal material or a corrosion-resistant metal material covering, or encasing, the cylindrical member. Coating the lead weight with such a material solves, or at least severely reduces, the problems caused by oxidation.

Examples of inert metals include, but are not limited to: gold, silver, copper, rhodium, platinum.

The aforementioned corrosion-resistant metal material is resistant (either to a very high degree, or completely) to corrosion at least at ambient temperatures. It is noted that plating a lead weight only provides a solution for one aspect of the problem, namely that of corrosion. However, this solution does not solve the problems of swaging a soft metal into a wooden key which creates an outside pressure to begin with.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is

1. A method for installing a piano key weight in a piano key or damper, the method comprising:
providing a weight formed from material including a metal having a density greater than 12 grams per cubic centimeter;
inserting said weight into the piano key or damper.

2. The method of claim 1, further comprising:
providing an external thread on a curved surface of said weight; and
wherein said inserting of said weight includes screwing said cylindrical key weight into a corresponding hole in the piano key or damper.

3. The method of claim 2, wherein said corresponding hole has a diameter that is smaller than a diameter of said weight.

4. The method of claim 2, wherein said corresponding hole has an internal thread adapted to receive said external thread of said weight.

5. The method of claim 1, wherein said weight is cylindrical.

6. The method of claim 1, wherein said metal is tungsten.

7. The method of claim 1, wherein said material is an alloy.

8. The method of claim 1, wherein said material is tungsten carbide.

9. A method for installing a weight in a piano key or damper, the method comprising:
providing a weight formed from material including a metal sufficiently strong to form a thread on a surface thereof;
forming said thread on said surface; and
inserting said weight into the piano key or damper.

10. The method of claim 9, wherein said inserting of said weight includes screwing said weight into a corresponding hole in the piano key or damper.

11. The method of claim 9, wherein said corresponding hole is has a diameter that is smaller than a diameter of said weight.

12. The method of claim 9, wherein said corresponding hole has an internal thread adapted to receive said external thread of said weight.

13. A weight for a piano key or damper, comprising:
a material including at least a metal having a density greater than 12 grams per cubic centimeter.

14. The weight of claim 13, wherein said metal is tungsten.

15. The weight of claim 13, wherein said material is a metal alloy.

16. The weight of claim 15, wherein said metal alloy is tungsten carbide.

17. The weight of claim 13, wherein said material has a cylindrical shape.

18. The weight of claim 13, further comprising a threaded surface.

19. A weight for a piano key or damper, comprising:
a material including at least a metal sufficiently strong to form a thread on a surface thereof; and
wherein the weight has a thread formed on said surface.

20. The weight of claim 19, wherein said material is resistant to corrosion at least at ambient temperatures.

21. A weight for a piano key or damper, comprising:
a cylindrical member made of lead; and
at least one outer layer of an inert metal material or a corrosion-resistant metal material covering said cylindrical member.

22. The weight of claim 13, wherein said inert metal is selected from the group including: gold, silver, copper, rhodium, platinum.

23. The weight of claim 13, wherein said corrosion-resistant metal material is resistant to corrosion at least at ambient temperatures.
